(19) United States
(12) Patent Application Publication
(10) Pub. No.: US 2017/0262451 A1
(43) Pub. Date: Sep. 14, 2017

(54) SYSTEM AND METHOD FOR AUTOMATICALLY CALCULATING CATEGORY-BASED SOCIAL INFLUENCE SCORE

(71) Applicant: Lauren Elizabeth Milner, Ft. Lauderdale, FL (US)

(72) Inventor: Lauren Elizabeth Milner, Ft. Lauderdale, FL (US)

(21) Appl. No.: 15/215,524

(22) Filed: Jul. 20, 2016

Related U.S. Application Data
(60) Provisional application No. 62/305,501, filed on Mar. 8, 2016.

(51) Int. Cl. G06F 17/30

(52) U.S. Cl. CPC G06F 17/3053; G06F 17/30598; G06F 17/30327

(57) ABSTRACT

A system method for a computer-implemented automated calculation of category-based scores for social influence, comprising scoring calculator that receives category information for a plurality of users with social activity metrics, and calculates a user score based on algorithmically analyzing received metrics; an identification and segmentation calculator that identifies a plurality of user-related categories and segments users into user-related categories; and a suggestion engine that presents opportunities to users based on a user categories.

### CROSS-REFERENCE TO RELATED APPLICATIONS

This application claims the benefit of priority to U.S. provisional patent application Ser. No. 62/305,501, filed on Mar. 8, 2016, entitled “SYSTEM AND METHOD FOR VALUATING USER EQUITY BASED ON CALCULATED SOCIAL INFLUENCE” the entire contents of which are hereby incorporated herein by reference.

### BACKGROUND OF THE INVENTION

Field of the Art

The disclosure relates to computer-implemented calculation of category-based social influence score.

Discussion of the State of the Art

It has only been in the recent past that an individual's influence online and through social media has extended beyond simple metrics such as Twitter™ followers or Facebook™ friends, or the average number of likes or favorites that may be received across a plurality of posts. Now, we have more meaningful metrics such as reach and engagement that allow businesses to assess how well someone manages their social presence and networks. There is also a wide selection of social media influence measurement tools, each offering a slightly different method of evaluation of social media worth. For example, Hootsuite™ allows an account to see associated Klout™ scores when viewing a profile in a dashboard. Where a Klout™ score is a unique number from 1 to 100 that reflects a user's general social media influence, calculated based on the user's levels of reach and engagement with their audience—the bigger the influence, the higher the score. While Klout™ is known as quickest, most straightforward way to evaluate someone's social media influence, it fails to take into account an individual's categorical social media influence. For example, a user may have a high Klout™score and be highly influential in a particular field (for example, economics) but may have a low influence in another field (for example, environmental activism). In this regard, leveraging a user with a high overall Klout™ score to distribute information to their online networks on environmental activism would not have desirable or effective results. Other social media influence measurement tools, similarly don't give a conclusive verdict, but instead show statistics on metrics such as reach, engagement, sentiment, number of retweets, etc. These rely on an individual to assess that user's level of influence, and fail to account for “categorical” quality of the user distributing information and the likelihood that their network receiving the information is interested in the information.

Another tool to measure levels of influence known in the art is PeerIndex™. The focus of PeerIndex's™ social media influence evaluation tool designed to measure an audience. PeerIndex™ allows searches for influential followers in a particular field by hashtag or keyword and filter by geographical location. Similar to Klout™, PeerIndex™ provides a score, which is based on how active a user may be on social media, how often other users engage with the user, and how influential the user's social media following currently may be. While PeerIndex™ can evaluate based on keyword, it only evaluates based on the keyword and does not account for the strength of a user's network based on category and fails to evaluate the influence of any and all profiles (individual and company) on social media.

Another tool to measure levels of influence known in the art is uberVU™ via Hootsuite™. The platform surfaces influencers who are actively driving a conversation in real-time. Rather than basing influence solely on a number of followers, uberVU™ determines influence based on relevance to specific search terms. uberVU™ uncovers in-depth data on influencers who are currently driving a conversation around, for example, a particular topic, brand, company or product and actively increasing engagement and extending reach. uberVU's™ Signals feature provides alerts to users of any new influencers, presents the influencer's social profiles, breakdown of followers, associated Klout™ score as well as a Twitter influence map, which visually represents the distribution of the influencer's tweets. This tool, while helpful for engaging in real-time conversations with influencers for marketing purposes, does not consider the influence of any and all social media profiles, and their influence, general and categorical, on their network.

Another tool to measure levels of influence known in the art is Kred™. Similar to Klout™, Kred™ also gives a social media account a score. The score is comprised of influence and outreach whereby influence is based on the amount of mentions, retweets, and replies to a user, and outreach relies on mentions, retweets and replies sent by a user. The Kred™ influence measurement tool displays a Global Kred™ by default, but a user can also see the breakdown of their Kred™ score based on different fields in the event that a user desires to increase influence or reach to a certain kind of professional. A user may also endorse other users by giving them “Kred”, which increases their Global score. Kred™ gives a map with geographical locations showing where a user's social media influence is the highest. Kred™ also summarizes a user's account's best-performing posts, as well as a mention summary for each month to see which other users a user may interact with the most. Whereas Kred offers insight into a social media profile's general influence and engagement by location, it overlooks the categorical influence of that profile and their network.

Another tool to measure levels of influence known in the art is Twtrland™. Twtrland™ measures social media influence based on statistics it collects from Twitter, Facebook, and Instagram. There is also an opportunity to search influencers on Twtrland™ by skill, location, or name. If a user is, for example, a human resources recruiter or manager seeking to fill a job position, the user may want to check a social media influence of a particular candidate, for example, by looking the candidate up by name. The user's Twtrland's™ profile may show fields where they may be influential, an overview of top content, as well as influential users in their network. Twtrland™, like the other tools mentioned above, does not consider the influence of a profile in defined categories or industries and the likelihood of the profile having a network that is listening, engaging and also influential in similar categories.

What is needed, is a means to provide more granular categorical social influence calculation and valuation for a plurality of profiles. A system to provide multiple scores that value an individual's social influence in a category or in many categories would be in improvement over systems known in the art that value social influence based on the general presence and activity of users. Further what is needed is a means to quantify social influence into a “distribution rate” in a way that equates categorical social influence to a monetary or share-based value (for example, in investing, this would be exchanging a monetary perk or equity in an equity crowdfunding offering for the online marketing of that offering generated by a user or entity; or for example, in retail transactions, this would be exchanging a coupon, discount or any other valuable good for the online marketing of a purchase by an user or entity).

### SUMMARY OF THE INVENTION

Accordingly, the inventor has conceived and reduced to practice, in a preferred embodiment of the invention, a system and method for computer-implemented automated category-based valuation of social influence.

According to a preferred embodiment of the invention, determining a valuation of a profile's “online marketing” worth (via an equity distribution rate) based on that profile's general and industry-specific (i.e. category-based) online and social media influence score, which takes into account the connections a user or entity holds to other accounts, enables a plurality of corporations, companies, startups, small businesses, platforms, and/or other entities that are marketing an idea, product, brand, opportunity and/or investment to more effectively and accurately target, engage in, and optimize crowdsourced marketing efforts. Moreover, by calculating a plurality of category-based influence scores, an entity, for example, may intelligently rank and compensate profiles for providing marketing support and/or service to or on behalf of their entity, through online and electronic social channels as recoded by the user's profile. In a preferred embodiment of the invention, a user profile's social media eco-system, comprised of electronic social media accounts and connected networks, which can include but are not limited to Facebook™, Instagram™, Twitter™, Periscope™, LinkedIn™, SnapChat™, Pinterest™, and the like, may be integrated into a network-connected computer system where historical and current data on the profile, which includes, but is not limited to, the quality and quantity of the user's network, the quality and quantity of that user's network's network (for example, two, or more, degrees of separation), the user's total and average reach (as indicated on the user's profile), the profile's total and average social media engagement which may include likes, dislikes, follows, shares, comments, interests, hashtags, etc. as well as category-based social influence indicators are collected and analyzed. The data on a profile provided by social media integration may then be applied to a specially programmed computer with instructions thereon to calculate that profile's “General Influence” score which may be a value percentage, equity distribution rate ranging, for example, a numeric range from 0 to 1 calculated as a fraction of a common share, or a score based on another scale. Further, the data on a profile provided by social media integration can then be applied to the computer-implemented algorithm on a specially programmed computer to determine a narrower score of influence defined as a “Category Influence” score, which also may be a value percentage or equity distribution rate ranging from 0 to 1 calculated as a fraction of a common share or a score based on another scale. Both General and Category-based scores may be able to be recalculated periodically to account for increases or decreases in social media influence by category or overall, to control risk (similar to a credit score) and identify higher performing profiles. If a user's profile indicates a high or increased activity on electronic social media channels (for example, generally overall or in a particular category), the associated score may increase. If a user's profile indicates low or decreased activity on electronic social media channels (for example, generally overall or in a particular category), the associated score may decrease. The periodic recalculation is designed to encourage profiles to grow their social influence and expand their social networks (for example, grow online social influence overall or for a particular category). By determining a profile's social influence score in a specific category and compensating that profile for marketing a specific idea, product, service, brand, opportunity and/or investment behind an offering in a specific category, a preferred embodiment of the invention may be able to equitably deploy shares to a user's profile in a way that may represent compensation to a user for their online marketing support and/or service and may deliver a highest return-on-investment for corporation, company, startup, platform, and/or any other entity that may be marketing an idea, product, service, brand and/or investment.

In a preferred embodiment of the invention, a plurality of user profiles are configured on a system comprising a specially programmed computer-implemented automated valuation computer that stores a plurality of connections to connect to a plurality of electronic social media accounts and networks corresponding to each user. The system may then iteratively traverse a plurality connection for a pre-configured number of degrees of separation. The iterative calculation calculates a weighting using a social influence reach for each connection of a particular user in order to effectively determine the cumulative influence for the user based on a particular category (for example, investment, business or industry category). Once a social influence value is calculated by category, a distribution rate (or value percentage) is set for the user for each category. The distribution rate then determines how many shares (or fractional shares) or another form of incentive, a user may be entitled to receive as compensation for distributing information on social media and engaging other users in their networks to reserve and/or purchase shares, goods or services in or from a particular company in the category. In some embodiments, a bonus number of shares (or fractional shares), or another form of incentive may be assigned to the user's profile once certain preconfigured milestones are recorded to the profile (for example, distributing information and engaging the highest number of users who reserve and/or purchase shares, goods or services). In some embodiments, a category distribution rate may be weighted by a user's overall social influence distribution rate as an additional element in the calculation.

In another embodiment, entities who provide shares as compensation to users for their marketing support may assign shares or another form of incentive into a special fund that holds other entities' shares and/or units representing value. According to the embodiment, a user's profile may receive a calculated number of shares (or fractional shares) or units of the fund based on a specific distribution rate as compensation for certain milestones recorded by the user's profile.

In another embodiment, users may exchange share reservations and share compensation on an exchange, in a free exchange or in a barter-like system by requests and interaction between profiles.

In some embodiments, the system, based on a plurality of characteristics such as adoption rate, speed of reservation, comparison of influencer's score to reservation rates, aggregated score for influencers active with the share, etc., may assign a new value to reserved shares enabling an exchange of shares between different entities and/or categories based upon demand. In this regard, the system may display an indication of potential value for both reserved shares and compensated shares before they are available to the public for purchase through an initial public offering.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary architectural arrangement for a computer-implemented automated category-based social influence score calculation, according to a preferred embodiment of the invention.

FIG. 2 is a flow diagram illustrating an exemplary overview of a method for a computer-implemented automated valuation of calculated social influence, according to a preferred embodiment of the invention.

FIG. 3 is a flow diagram illustrating an exemplary algorithm for computer-implemented automated valuation of calculated social influence using equity, according to a preferred embodiment of the invention.

FIG. 4 is an exemplary schematic illustration of profile records, according to a preferred embodiment of the invention.

FIG. 5 is an exemplary schematic illustration of a relationship-based tree structure for connections, according to a preferred embodiment of the invention.

FIG. 6 is a block diagram illustrating a plurality of exemplary objects for a computer-implemented automated category-based social influence score calculation, according to an exemplary embodiment.

FIG. 7 is a block diagram illustrating a plurality of exemplary global variables for a computer-implemented automated category-based social influence score calculation, according to an exemplary embodiment.

FIG. 8 is a flow diagram illustrating an exemplary algorithm to compute a category-based influence score for a computer-implemented automated category-based social influence score calculation, according to a preferred embodiment of the invention.

FIG. 9 is a flow diagram illustrating an exemplary algorithm to compute a competition payout for a computer-implemented automated category-based social influence score calculation, according to an exemplary embodiment.

FIG. 10 is a block diagram illustrating an exemplary hardware architecture of a computing device used in an embodiment of the invention.

FIG. 11 is a block diagram illustrating an exemplary logical architecture for a client device, according to an embodiment of the invention.

FIG. 12 is a block diagram showing an exemplary architectural arrangement of clients, servers, and external services, according to an embodiment of the invention.

FIG. 13 is a block diagram illustrating an exemplary hardware architecture of a computing device used in various embodiments of the invention.

### DETAILED DESCRIPTION

The inventor has conceived, and reduced to practice, a system and method for a computer-implemented automated category-based social influence score calculation.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Conceptual Architecture

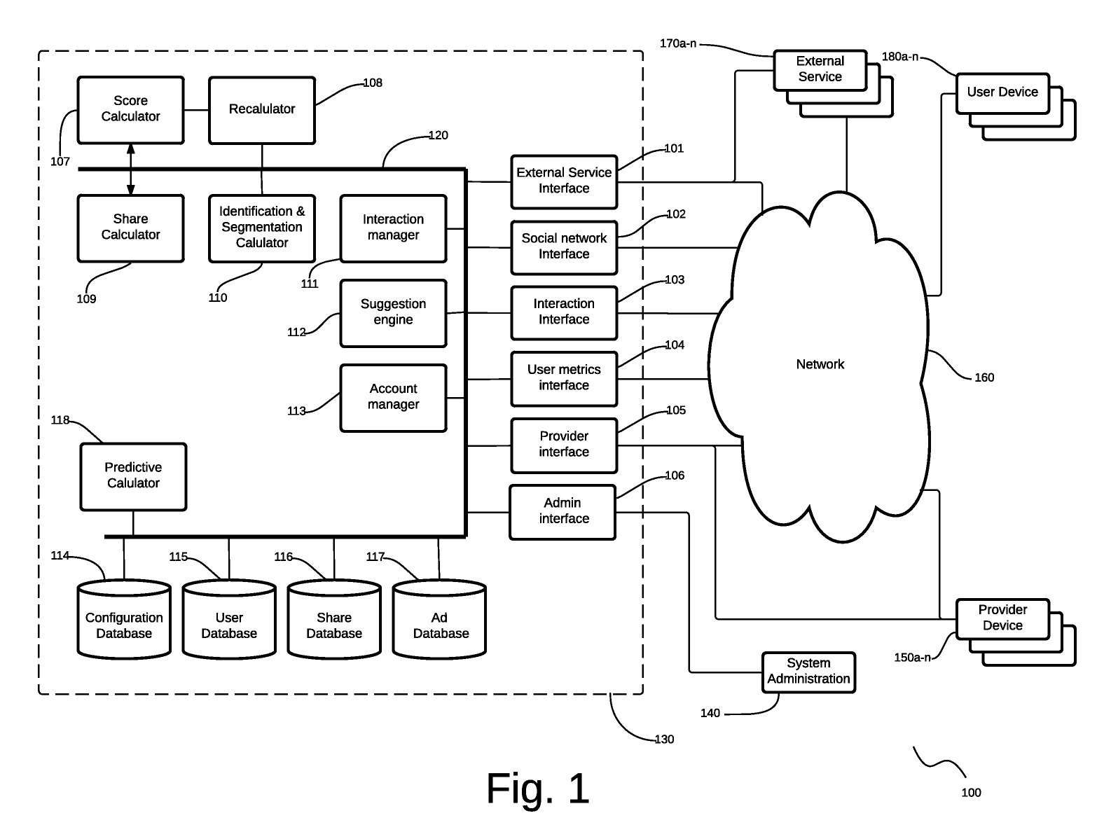

FIG. 1 is a block diagram illustrating an exemplary architectural arrangement for a computer-implemented automated category-based social influence score calculation system 100, according to a preferred embodiment of the invention. According to the embodiment, a category-based influence calculation system 130 may comprise a plurality of external service interfaces 101 that may be configured to connect to a variety of external services 170a-n via a network 160. For example, an external service interface 101 may comprise a social network interface 102 configured to connect to a plurality of external services 170a-n, that may each comprise a variety of social media profiles and networks associated with a user as configured in a user database 115 (For example including, but not limited to, Facebook™, Twitter™, LinkedIn™, Instagram™, or Snapchat™). Some of these services 170a-n may carry an enormous amount of information on lifestyles, interests, connections, or activities that may benefit targeting and marketing efforts. Interaction manager 111 collects interactions that may be received via an interaction interface 103 within category-based influence calculation system 130, such as user interactions received from a user device 180a-n, interactions from a provider device 150a-n, entity interactions, information from external sources, and other interactions within category-based influence calculation system 130. User metrics interface 104 may collect a variety of user-related data that may comprise information such as followers, connections, average influence, average audience, activity, engagement, or social media metadata such as “hashtags” (both from a general and category-based perspective). Category-based influence calculation system 130 may use user profile information for targeting purposes. In some embodiments, comments (including any metadata such as hashtags) may be collected from user's social media accounts and optionally stored in a user database 115 for future reference. A provider interface 105 may be used to receive metrics, configuration, or other information from a plurality of provider devices 150a-n, for example to receive network information pertaining to a particular social media network or to receive investment information for potential share reservation opportunities to be presented to qualified users. An administration interface 106 may be used to enable a system administration device 140 to modify configuration or operation of category-based influence calculation system 130, for example to configure metrics and score weighting parameters, or to monitor or audit operation such as by reviewing logged information.

Identification and segmentation calculator 110 may determine and segment a plurality of users based on a plurality of metrics, including but not limited to social influence (e.g. Klout™ Score), mentions in traditional media, participation in related online forums, blogs, commentary, etc. to estimate their potential worth. In some embodiments, identification and segmentation calculator 110 may segment a user based on information above into a certain type of life cycle or tier (e.g. gold, silver, bronze) by category whereby a particular score for one user may be different across categories. Categories, metrics, and other configuration information for use by identification and segmentation calculator 110 and other components may be stored in and retrieved from a configuration database 114.

In various embodiments, score calculator 107 may calculate a category-based influence score, and may include an association of a number of social metrics such as, including but not limited to: (1) social network size (for example, a total size of the social network). It can be appreciated by one with ordinary skill in the art that, the greater the size of a network, the more opportunity a user may have for social influence; (2) a user's network size (for example, total number of profiles comprising a social network of the user's social media connections). It can be appreciated by one with ordinary skill in the art, that the greater the size of a network for a user, the more opportunity the user has for social influence; (3) network engagement (for example, total amount of likes, retweets, shares, comments received on user-generated content or comments, or to actions over a certain period of time, or a combination of one or more of these elements). It can be appreciated by one with ordinary skill in the art, that the greater network engagement a user displays on social media, the more opportunity a user has to influence network connections (4) user-generated actions over a certain period (for example, total number of social media actions, such as, post plus shares not generated by another user, or a combination thereof). It can be appreciated by one with ordinary skill that the number and quality of content of social media actions of a user may determine the interests and habits of a user in engaging their social media network. If the user is on the low end of engagement, it may suggest that the user may then have lower opportunity for social influence since he/she is not active often; however, if a user is on the high end, it may also suggest a lower opportunity for social influence given the volume of posts (frequency can be construed as hasty); (5) user engagement over a certain period (for example, total number of likes, retweets, shares initiated by the user on their social media network's actions). It can be appreciated by one with ordinary skill in the art, that a number of “supportive” engagements that a user provides to her network may be an indicator of activism or closeness (or both), with their network and could be another indicator of social influence; (6) Tone over a certain period (for example, occurrence of negative, positive and neutral words within posts over a certain period). It can be appreciated by one with ordinary skill in the art, that a number of various natural language processing, text analysis and computational linguistics to identify and extract subjective information in online social media communications may be used to identify tone and indicate a user's personality. It can be appreciated by one with ordinary skill in the art, that the ranking of a user's likelihood to post a negative or positive post may provide another indicator of social influence; (7) user advocacy (for example, total number of companies, places, brands, people tagged in social media actions over a certain period of time). It can be appreciated by one with ordinary skill in the art, that measuring user advocacy may be an indicator of brand and network advocacy or support, and therefore, may also indicate a user's ability to influence the decision-making of their network connections.

Influence indicators for score calculator 107 may include (1) response of network of connections (for example, connections of other user devices 180a-n, both registered and non-registered to category-based influence calculation system 130, as configured by connection object 420, or other connections accessed through social network interface 102, or both, associated to user device 180a), including network engagement per frequency of user device 180a-generated actions over a certain period of time (for example, total number of likes, retweets, content sharing received to a user device 180a's social media actions computed with total number of social media actions including, but not limited to, content posting plus content sharing not generated by another user). It can be appreciated by one with ordinary skill in the art, that responses by social network connections (positive or negative) may be an indicator of a user's social influence. The more network engagement per social media action suggests the value of a user's activity; (2) network (for example, connections of other user devices 180a-n, both registered and non-registered to category-based influence calculation system 130, as configured by connection object 420, or other connections accessed through social network interface 102, or both, associated to user device 180a) engagement rate, that is, social network connection engagement by social network size (for example, total number of likes, retweets, content sharing received to actions over a certain period computed with total # of a user's social media connections). It can be appreciated by one with ordinary skill in the art, that the network engagement rate may be an indicator of value associated to a user device's 180 network (i.e. how many connections are viewing and acting on user actions); (3) average connection (for example, connections including other user devices 180a-n, both registered and non-registered to category-based influence calculation system 130, as configured by connection object 420, or other connections accessed through social network interface 102, or both, associated to user device 180a) engagement rate of connections (for example, connections of other user devices 180a-n, both registered and non-registered to category-based influence calculation system 130, as configured by connection object 420, or other connections accessed through social network interface 102, or both, associated to user device 180a) over a pre-configured period of time (for example, daily, weekly, monthly, etc.), for example, total number of likes, retweets, content sharing initiated by a user device on their social network connection's actions computed with the pre-configured period of time. It can be appreciated by one with ordinary skill in the art, that the average user engagement rate may be an indicator of “closeness” or “activism” to or within the network of connections, that is, the engagement of the user device 180a with her network other user devices 180a-n of social connections.

In various embodiments, score calculator 107 may consider a number of exemplary online social media metrics in a category-based influence score algorithm, including, but not limited to: (1) a total number of hashtags included in user-generated social media actions or content by a user device 180a over a certain period of time; (2) a total number of “category-specific” hashtags, that is a target category for a category-based influence score in user-generated social media actions over a certain period of time; (3) a total number of companies and brands followed by the user device 180a; (4) a total number of companies and brands followed by user device 180a for a certain category: (5) an education level associated to a user associated to user device 180a, for example, highest level of education earned for the user (for example, 0.25 for AA, 0.50 for BA, 0.75 for Masters); (6) a field of study associated to a user associated to user device 180a (for example if the field of study in within the target category=1, or if out of category=2); (7) a profession associated to the user associated to user device 180a (for example, a profession within the target category=1, or out of category=0.5); (8) interests associated to the user associated to user device 180a (for example, total number of interests indicated by social media at a given time; (9) similarly, a total number of categorical interests indicated by social media at a given time; (10) a group membership associated to the user associated to user device 180 (for example, user initiated member in a certain professional or interest categories).

Further, one or more calculations may be included, in conjunction, or as a stand-alone calculation, with a score calculation algorithm for score calculator 107 including, but not limited to: (1) a total number of categorical hashtags associated to user-generated social media actions associated to user device 180a over a certain period of time divided by a total number of hashtags in user-generated social media actions associated to user device 180a over a certain period of time; (2) a total number of category-based interests indicated by social media, associated to user device 180a, at a given time divided by a total number of interests indicated by social media, associated to user device 180a, at a given time; (3) a highest level of degree earned (0.25 for AA, 0.50 for BA, 0.75 for Masters) associated to first user profile 400 corresponding to user device 180a divided by a specific degree earned (B.S. in Engineering) associated to first user profile 400 corresponding to user device 180a (for example, defined by 1); (4) a total number of companies and brands followed by user device 180a in a certain category divided by a total number of companies and brands followed by user device 180a; (5) an educational designation associated to a user profile 400 corresponding to user device 180a multiplied by a professional designation associated to a user profile 400 corresponding to user device 180a.

In some embodiments, score calculator 107 may calculate (or translate) a category-based influence score as a user equity distribution rate. Accordingly, score calculator 107 may calculate results and be defined as a user's equity distribution rate (hereinafter, referred to as “rate”), for example, a decimal value ranging from 0 to 1, that may be used to determine a user's “social value” in terms of shares (or fractional shares) or cash-equivalents that a user may earn per investment, as compensation for distributing information on that investment, based on, for example, milestones posted on milestones field 406 on an associated profile 401 corresponding to a user device 180 corresponding to the user. The rate, may then be based on the user device 180 distributing information or invitations, or both, to entice other users to reserve shares (for example, one of the equal parts into which a company's capital is divided, entitling the user to a proportion of the profits) to their profile via their user devices 180a-n. Share reservations may be, for example, a mechanism for reserving shares for purchase prior to a company's anticipated initial public offering or in a private offering. For example, a user may be encouraged or incentivized to “spread the word” about shares (or share reservations, or both) or another equity crowdfunding offering, by encouraging their contacts to reserve shares (or fractional shares) and in turn receiving an incentive or reward (such as a bonus to their value score, which may be used to “unlock” more shares or incentives later on) for those referred users that complete a reservation, or by simply directing their contacts to the Offering itself.

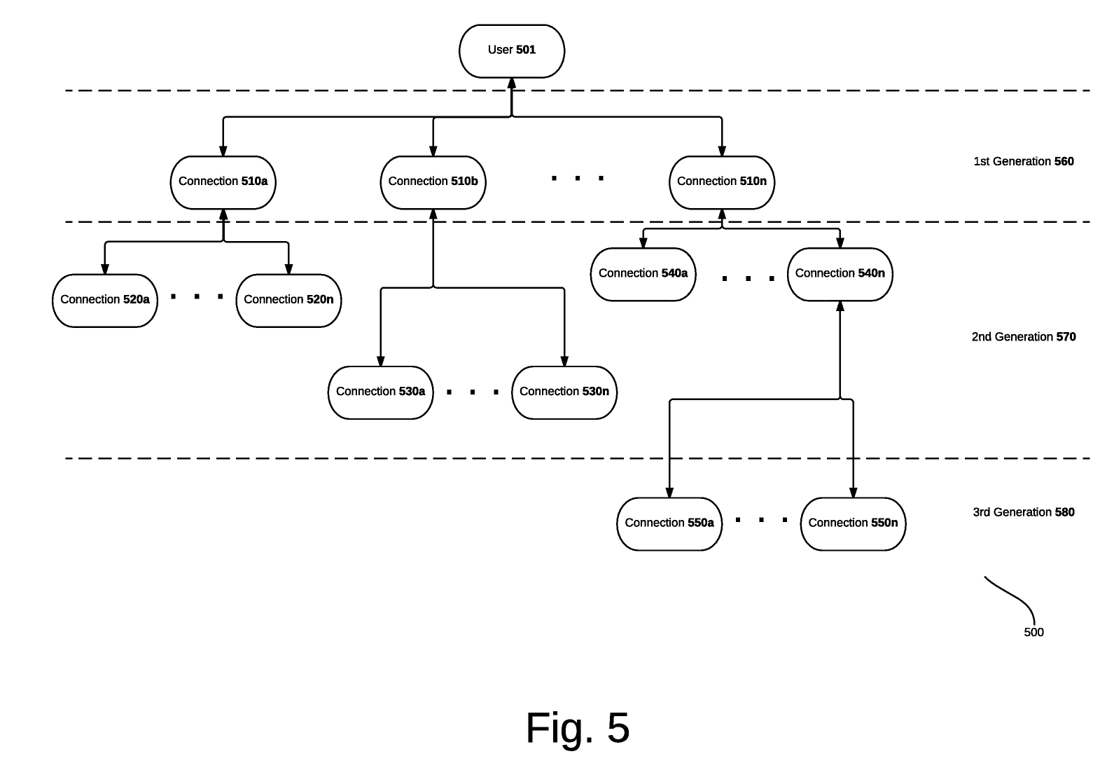

In some embodiments, a plurality of scores based on a calculated social influence may be assigned per category and be based on the interactive traversal of connections (for example, as described in FIG. 5) including connections of connections based on value or reach, or both, of a user's network. In some embodiments a plurality of social ranking scoring mechanisms (for example, Klout™) may be used, at least in part, in determining the score. A calculation for how many shares (or fractional shares) or another incentive that may be assigned to a particular profile may be based on the information mentioned above, as well as any additional information that may be available, such as a user's social networking history (for example, known posts or trends associated with their user profile or account). In some embodiments, an overall score for a user may weight a plurality of scores for each category, for example, the size and activity of a user's networks may be used in weighting the plurality of scores. In some embodiments, a gradient scale may be used based on the breadth of responses. In some embodiment, an engagement score and/or a reach score may be used. In some embodiment, a context-based score may be calculated based on category and user reach in certain contexts. In some embodiments, a score may be separated into sub components based on potential engagement, and results based on engagement when, for example, a competition ends. It can be appreciated that a competition may be an endeavor by an entity, for example, a company offering shares in advance of sale (share reservations), offering a campaign for user devices 180a-n registered with category-based influence calculation system 130 to begin distributing opportunities for other users 180a-n (both registered user devices 180a-n of category-based influence calculation system 130 and non-registered user devices 180a-n, or both) to take part in the share reservation process.

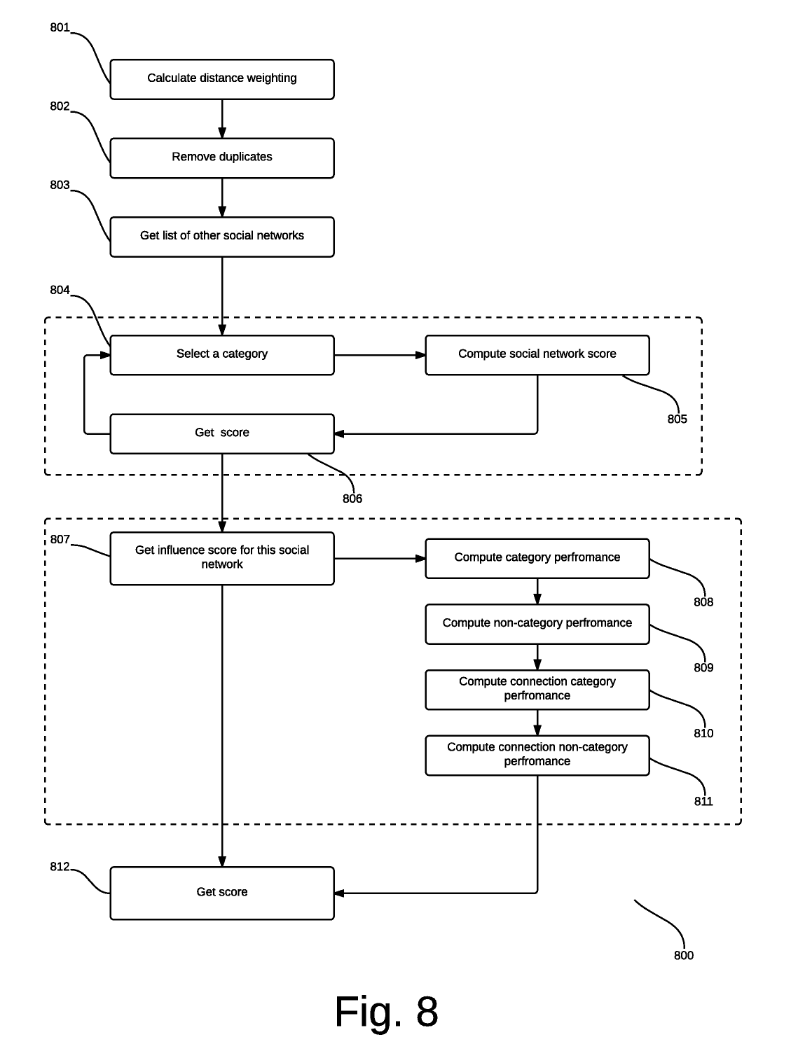

In a preferred embodiment, an algorithm for category-based influence score calculator 170 may include, for example, an algorithm outlined in FIG. 8.

In some embodiments, a social platform may be scored for efficacy based on category and stored within a connection object 420 in service score field 422 using the techniques (or a variation thereof) described above. For example, a professional network (for example, LinkedIn™, AngelList™, etc.) may be more valuable for opportunity distribution for profession-related or highly complex opportunities, whereas a personal network may be scored higher by score calculator 107 for other types of opportunities, for example, consumer, environment or political-based opportunities.

It should be appreciated that, at least, the metrics, calculations, translations, and the like, discussed above may be used separately, in various combinations, or in conjunction with other algorithmic entities for computing a range of possible scores for category-based influence scores for user devices 180a-n.

In some embodiments, a predictive score may be calculated to assess a new user device 180b that may have recently registered with category-based influence calculation system 130 and may have missing metric or profile information available. As such a predictive calculator 118 may use a pattern recognition or computational learning theory process known in the art to determine a score using inferenced or learning information using stored historical information from previous activity and transactions.

According to an investment share reservation distribution embodiment, user activity may be stored in a user database 115, for example, which users made share reservations (as opposed to those who may have explored options but did not actually complete a reservation) or which users made and followed through on reservations which resulted in the purchase of shares of equivalent value. Additionally, user metrics and attributes may also be stored in user database 115, for example, including but not limited to, profile and/or wallet contents, category influence, reach by category, success rate, peer reviews, or other attributes or information that may be associated with a particular user. In various embodiments, user database 115 stores information in, at least, a plurality of user profiles 400.

According to an investment share reservation distribution embodiment, a share calculator 109 may receive a user device 180a's “wallet” and may keep track of reserved shares and accumulated shares in user device's wallet. In some embodiments, at regular intervals, (for example, each day, week, month, or other time period) users may publicly post each of their investment reservation to their social media networks connected through social media interface 102. In this regard, they may earn fractions of shares or cash-equivalents in exchange for marketing, inviting, and/or posting information about the opportunity (for example, investment share-reservation opportunity). In this regard, the wallet may grow by a calculated distribution rate based on their social influence, social value or calculated score as applied to the specific investment or opportunity they are endorsing.

A recalculator 108 may be used to keep scores current by recalculating a score (as described above) at regular intervals (for example, every 1, 5, 10 or 20 days) to account for increases and decreases in social media value, activity and risk. If a user becomes more influential (for example, by increasing activity or expanding reach, or the like, on particular social channels), their score may increase. Conversely, if a user becomes less active and their reach or activity decreases, or both, their score may decrease. Accordingly, associated metrics in user profile 400 would be updated to keep a current score for user device 180a associated to the user.

Scores and calculations may be used by suggestion engine 112 to proactively present a variety of category-based sharing opportunities, for example, to distribute share reservation requests by user device 180a to earn shares, partial shares or another incentive by distributing information on the investment opportunity (share reservations) to other user devices 180b-n for consideration or reservation, or both. In this regard, investment opportunities may be targeted to a particular user based on a wide variety of information to present only the most ideal and relevant opportunities, for example, by taking into consideration, at least, a user's explicitly-stated preferences and profile information within an associated user profile 400, social connections configured in one or more associated connection objects 420, activities stored in one or more associated metrics object 430, as well as historical investment information and performance in category and non-category opportunities.

According to a crowdsourced-marketing embodiment, category-based influence calculation system 130 may determine, for example, the monetary value—fractional common share value or cash equivalent value—of a user's one-time social media influence in order to fairly reward users for informing their network of an idea, product, brand or investment on social media via social network interface 102. According to the embodiment, external services 170a-n may interface with a variety of online systems to perform various actions such as retrieve and present coupons, perks and news, and interface with ecommerce platforms as well as brokerage trading platforms, and other activities. Additionally, advertisements for presentation in an external service (for example, ads for companies in which a user may be interested, which may be presented to an associated user device 180a alongside other social network content for viewing by one or more user devices 180a-n) may be stored in and retrieved from an advertising database 117, and may be used, for example, to “pitch” new services, coupons, incentives and share reservation options to users in a targeted fashion. For example, user device 180a may be present an ad outlining available share reservations that a user of user device 180a may be interested in, a reminder of an existing reservation they may not have followed through on, a reminder of the user's ability to receive more share- or cash-equivalent based rewards for continuing to market it to their network connections, a notification to open a brokerage account or other service based provider account, or other such targeted advertising.

In a preferred embodiment, a user device 180a-n may be any appropriate mobile computing device (such as, a tablet or smartphone), a specially programmed computing device such as an ASIC or embedded device, or any other computing device capable of storing programming instructions in memory and executing them on a processor, and capable of communicating via a data network 160.

In some embodiments, analysis and calculations may be used further to valuate not only user profiles 400 but also businesses or corporations based on user-related activity, social reach, investment history, entities behind previous capital raises, and other metrics and scores which, in some embodiments, may also be stored in one or more user profiles 400. For example, companies that are publicly-traded may be valuated based on users that are investing in the company, such as by analyzing what categories users are actively investing in or have historically invested in, social activities and successes of investing users, other investments made by invested users (for example, “other companies users may invest in before/after having invested in a particular investment”), or a nature of investments being made by users (such as how many shares they purchase, for how much, or in what arrangement such as large quantities at once or smaller quantities repeatedly invested over a length of time). In this manner, social valuation may be used to broaden the valuation of businesses by considering their investing user base (i.e. investors) to form more precise estimations of a company's “worth”.

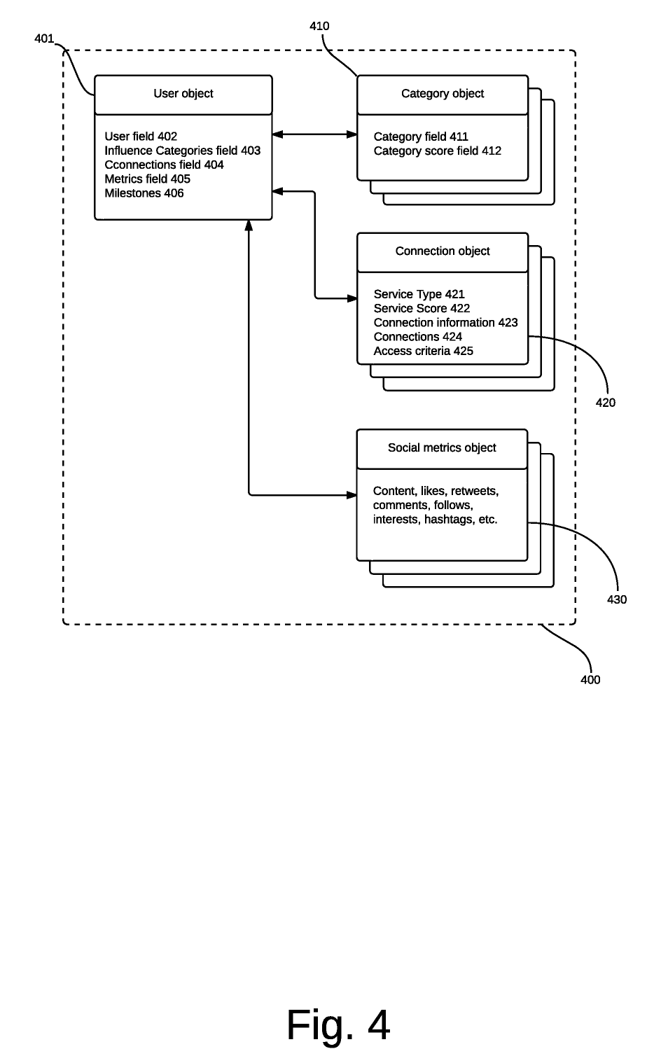

FIG. 4 is an exemplary schematic illustration of a profile record, according to a preferred embodiment of the invention. According to the embodiment, user profile 400 comprises a plurality of objects describing characteristics for each user device 180a-n configured in valuation category-based influence calculation system 130. Each user object 401 corresponds to one user device 180 of a plurality of user devices 180a-n and may be a record used category-based influence calculation system 130 as user devices 180a-n access category-based influence calculation system 130. Each user object 401 comprises at least user field 402 that contains an identifier (for example, a name or a user name associated to a connected user device 180) which identifies the specific user or member that corresponds to the user object 401; service connection field 404 may contain one or more category object identifiers in influence category field 404, each object identifier corresponding to a category object 410. This occurs when a user object has one or more categories comprising a non-null score value associated to a category for a user object. In some embodiments a score may be an integer (either positive or negative). In other embodiments, a score may be a cardinal number (non-zero positive number). In another embodiment, a score may be any decimal number. Service connection field 404, may contain one or more service object identifiers, each service object identifier corresponding to a service connection object 420. Connection field 404, may contain one or more service object identifiers, each service object identifier corresponding to a service connection object 420. Metrics field 404, may contain one or more metrics object identifiers, each metrics object identifier corresponding to a social metrics object 430.

Category object 410 comprises, at least, category field 411 and category score 412. Category field 411 corresponds to a preconfigured category in which a score is desired. For example, a category may be a particular industry or investment sector such as environment, telecommunications, automotive, business consulting, and the like. In other embodiments, categories may be a particular sport, sporting teams within a particular sport, genre of television, or the like. In other embodiments, categories may correspond to particular skills for an associated user and the score, a proficiency for the skill. It should be appreciated by one with ordinary skill in the art that any category can be configured for a specific embodiment to describe categories used in category-based influence calculation system 130. Category object 410 further comprises, at least, category score field 411 which may indicate a score associated to a corresponding category field 411. A score may be a value, percentage or rate ranging, for example, from 0 to 1, calculated, for example, as a fraction. In various embodiments, the score may correspond to a user's online social media influence, calculated based the user's levels of reach and engagement with an audience pertaining to category 411 and may be calculated using a number of elements such as historical performance for the category, predicted level of reach based on metrics, or the like, or a combination thereof. In some embodiments, a score may be calculated based on one or more degrees of analysis of characteristics of a connections within user object 401's network. In a preferred embodiment, the bigger the influence, the higher the score. In another preferred embodiment, the score may be computed as a rate (for example, a commission rate) that may correspond to a percentage of a common share of equity for a particular company configured within category-based influence calculation system 130 (as described previously).

Connection object 420 describes social connections and networks that a user device 180a may have, for example, user devices 180a-n (that are registered with category-based influence calculation system 130) or users connected to other social networks accessible through social networks interface 102 (for example, social networks known in the art such as Facebook™, Twitter™, SnapChat™, LinkedIn™, and the like) comprising, at least, service type field 421 (for example, a social network based on type such as personal or professional, or based on platform, such as, full social network service, chat service, communication platform, etc.); service score 422, for example a score calculated by score calculator 107 representing a score for the service based on the target category; connection information field 423, for example, a pointer or locator (for example, a URL) for social network accessed through social network interface 102; connections field 242 is a plurality of connections connected to the user as described in FIG. 5, that is a plurality of connected profiles and devices with various degrees of connection to share opportunities. It should be appreciated that some connections may already be registered with category-based influence calculation system 130, and others may not; access criteria field 425, for example, login and password information for the user to access information (such as, profile information, connection information, and the like) for one or more social network accessed through social network interface 102.

Social metrics object 430 may comprise information surrounding social media activity for an associated user object 401 for one or more social networks including, but not limited to category-based influence calculation system 130 or one or more social networks connected through social network interface 102, or a combination thereof. Metrics may include, but not limited to, (1) content, for example, content posted or shared by user device 180a associated to the corresponding user object 401; (2) likes initiated by user device 180a to content of others or likes received by other user devices 180b-n, (2) retweets initiated by user device 180a to content of others or retweets received by other user devices 180b-n to content of user device 180a; (3) comments retweets initiated by user device 180a to content of others or comments received by other user devices 180b-n to content of user device 180a; (4) follows initiated by user device 180a to other user devices 180b-n to content of user device 180a (or content) or follows received by other user devices 180b-n to user device 180a (or content of user device 180a); (5) interests configured for user device 180a; (6) hashtags included in content, searched, or followed by user device 180a; and the like.

It should be appreciated that a plurality of social metrics objects 430 may each describe a particular social network, or comprise aggregated metric information for one or more social networks.

Each user profile 400 can be associated with one or more other user objects 401. This occurs when one user device 180a-n is connected to another user device 180a-n through an online network (for example, a social network such as Facebook™, Twitter™, SnapChat™, LinkedIn™, and the like). The association is defined by connections field 424 containing one or more pointers that corresponds to one or more other-user objects 401.

User profile objects 400 and associated user, category, and connection objects may be stored in user database 115.

### Detailed Description of Exemplary Embodiments

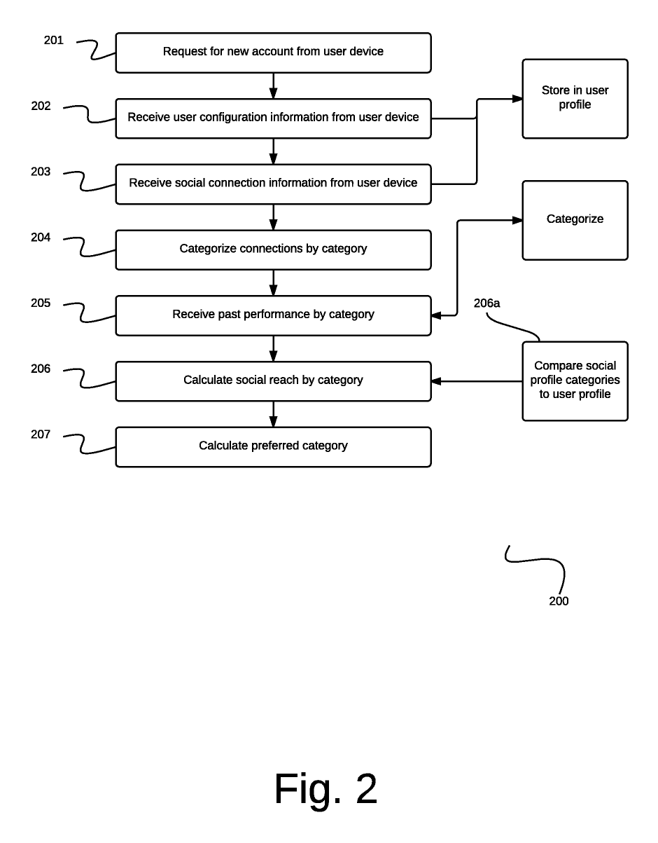

FIG. 2 is a flow diagram illustrating an exemplary configuration of a computer-implemented automated valuation of calculated social influence, according to a preferred embodiment of the invention. In a first step 201, a request is received from a user's mobile device 180a to establish a new account in category-based influence calculation system 130. In a next step 202 a request is received from user device 180a comprising new account configuration information. Account information may comprise such details as an account name and contact information, for example, a physical address, an email address, and account preferences. Account preferences may comprise information pertaining to desired categories of interest for investment opportunities (for example, high-tech companies, environmental companies, blue chip companies, or other potential investment opportunities that may be of interest to a particular user or user category). Preferences and information from user device 180a is stored in first user profile 400

In a next step, 203 a plurality of social media network connection information is received from user device 180a and stored in first connection object 420 associated to first user profile 400. For example, a Facebook™ URL corresponding to a business or personal profile, a LinkedIn™ URL corresponding to a user profile, a twitter handle, influencer score (for example, Klout™, Hootsuite™), and the like.

In a next step 204 connections associated to user device 180a are analyzed, categorized and scored for buying potential. In a next step 205 a connection to trading accounts or trading history may be access (for example, by connecting to one or more configured online brokerage accounts or other personal financial database such as Quicken™, if received from user device 180a. The results may be summarized by category and stored in a share database 116 with a score for the category. The score represents a measurement for success, activity, or knowledge in a particular area. In a next step 206 a user equity distribution rate calculator 107 may calculate a user's social influence score by category, based at least in part on results from one or more previous steps. In a final step 207, a category-based influence score is calculated as outlined in FIG. 8.

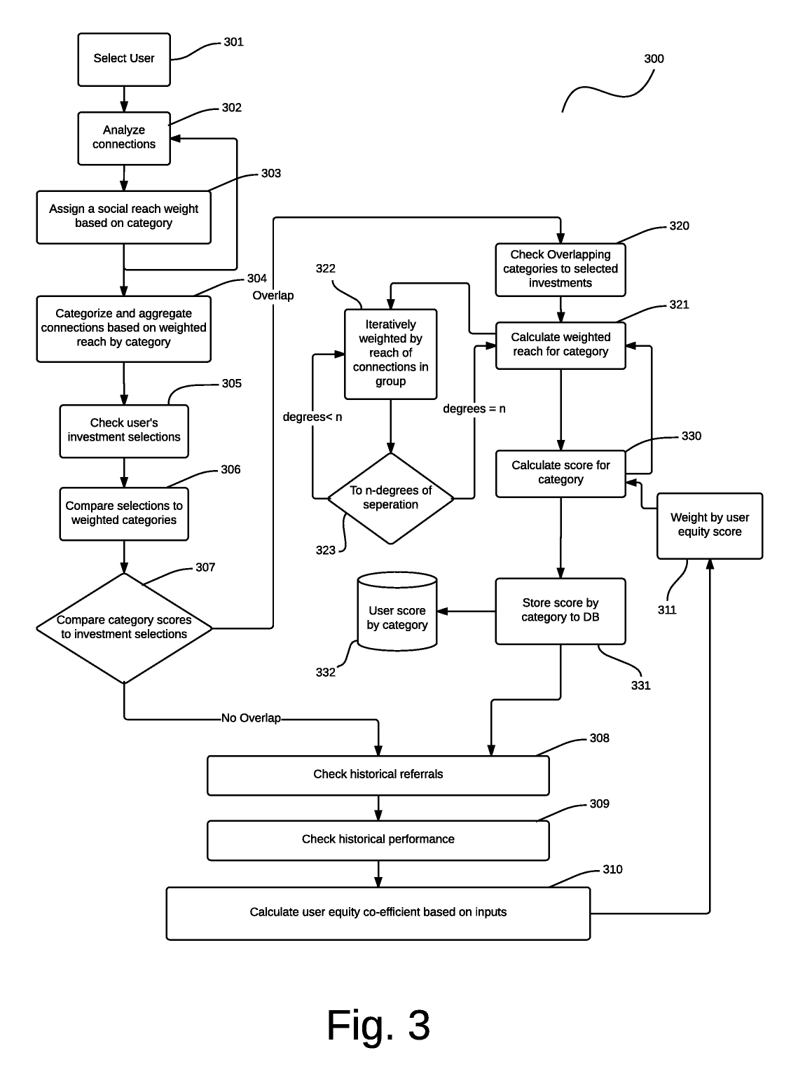

FIG. 3 is a flow diagram illustrating an exemplary algorithm 300 for computer-implemented automated valuation of calculated social influence using equity, according to an investment share-reservation distribution embodiment. In an initial step 301, a first user device 180a may be selected for valuation by category-based influence calculation system 130. In a next step 302, the user's social media connections retrieved using connection information from first connection object 420 (associated to first user profile 400 corresponding to first user device 180a) may be analyzed, for example by retrieving known profiles and accounts associated with the user device 180a and examining the activity of these accounts on external services 170a-n or connected through social network interface 103 such as a social media network. Categories and metrics may be retrieved from a configuration database 114 and used to assign weighted “social reach scores” to a user based on, at least a traversal of nodes of a first connection tree structure 500 (see FIG. 5), and analysis may continue in a circular fashion as shown, wherein a user's activities are continually analyzed and scores are updated.

In a next step 304, weighted reach scores may be used to categorize and aggregate user device 180a's social connections, and these may then be stored in a user database 115 for future reference. In a next step 305, a user's investment selections (as may be retrieved from a user database 114 or observed from user activities, or from external services interface 101, or a combination thereof) may be examined and then 306 compared to weighted categories to determine 307 whether there is an acceptable overlap. If there is no overlap, historic referrals may be checked 308, as well as historical performance of the particular user 309, and then user device 180a's score may be calculated 310 from these inputs. In a next step 311, user device 180a's score may be used by share calculator 109 to calculate an equity value percentage based on the score and used to weight categorical equity scores (for example, a percentage that user device 180a may get upon successful delivery or signup, or both, for distributing share-reservation opportunities).

Referring back to step 307, If an overlap is detected when comparing category-based scores to investment selections 307, overlapped categories may be compared to selected investments 320. Comparison results may be used to calculated a weight reach score for each category in a next step 321, which may then be iteratively weighted by the reach of each of user device 180a's connections within a group 322 to a configured n-degrees of separation 323 (for example, as outlined in FIG. 5). When the desired degree of separation is reached (that is, all appropriate connections have been exhausted), weighted reach may be re-calculated 321, and then used to calculate a category-based influence score (which, in some embodiments, may correspond to a value percentage) for the category in step 330 (for example, as outlined in FIG. 8). The computed category-based influence score (and associated category equity value percentages) may then be stored in a next step 331, where they may be retained in a user database 322 for future reference and further calculations and re-calculations.

FIG. 5 is an exemplary schematic illustration of a relationship-based tree structure for connections, according to a preferred embodiment of the invention. According to the embodiment, user 501 may be a user device 180a with an associated user profile 400 describing user information, associated social networks and connection information. In this regard, user 501 has n connections to a plurality of other users 510a, 510b to 510n who also correspond to a plurality of user devices 180b-n. Connections 510a-n comprise a first generation of connections 560 to user 510 (collectively hereinafter referred to as “first generation connections”) and may be direct connections on category-based influence calculation system 130 or associated social networks connected through social network interface 102 (for example, friends on Facebook™ or professional connections on LinkedIn™, or other connected social networks). It should be appreciated that connections 510a-n may be particular to one social network or an aggregation of a plurality of connections from more than one social network, or a combination thereof. Further according to the embodiment, first generation connection 510a may have a plurality of connections 520a-n, first generation connection 510b may have a plurality of connections 530a-n, and first generation connection 510n may have a plurality of connections 540a-n. In this regard, connections 520a-n, 530a-n, and 540a-n comprise a second generation 570 of connections (collectively hereinafter referred to as “second generation connections”) for user 501 (that is, there are two degrees of separation between user 501 and the second generation connections. Further according to the embodiment, second generation connection 540n may be connected to connections 550a-n. In this regard, connections 550a-n comprise a third generation of connections (hereinafter referred to as “third generation connections”) to user 510. It should be appreciated that this arrangement can continue for many more generations and provide a vast network for user 510 to share content and opportunities. Further, score calculator may use connection tree 500 to iteratively traverse nodes identifying connections that are, for example, within a target category, or to analyze connections for propfiles containing key word suggesting category, or identifying connections who are connected to a large number of connections that may be within category (or have a high influence score).

Referring again to FIG. 5, in a preferred embodiment, score calculator 107 may weigh each generation based on a “distance” to user 510 (that is, the more generations, the further the distance to user 510), for example, a plurality of first generation connections may have a high weight when calculating a category-based influence score for user 510 (for example, when a first generation has a high number of “in-category” first generation connections), whereas each successive generation may be weighted less when calculating a category-based influence score, for example, the further distant a connection is to user 510, the less it may factor in the calculation of a category-based influence score for efficacy is distributing content or opportunities, or both. In this regard, any derivative rate or score will be affected by distance of in-category connections.

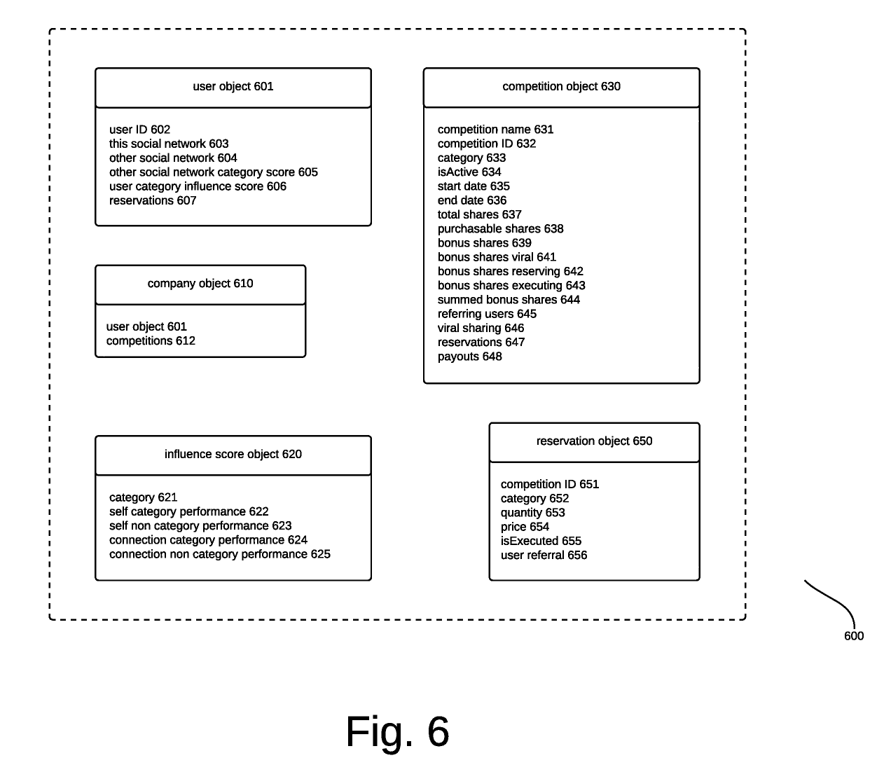

FIG. 6 is a block diagram illustrating a plurality of exemplary objects for a computer-implemented automated category-based social influence score calculation, according to an exemplary embodiment. According to the embodiment, a plurality of objects 600 may be used to define data structures for computing a category-based social influence score for a plurality of users. User object 601 may define characteristics about each user of social influence score calculation system 100 and comprises, at least, fields: (1) user ID 602 which may be a unique identifier assigned to each user of social influence score calculation system 100, for example, when a user via user device 180a registers to category-based influence calculation system 130, a unique identifier may be assigned to the user and stored within a corresponding user object 601. (2) this social network 603 corresponds to, for example, one or more connected user devices 180b-n that user device 180a may be connected to as configured in user database 115. (3) other social network 604 may refer to one or more social networks known in the art connected (for example, one or more social networks to which user device 180a is a member of) to user device 180a via social network interface 102. (4) other social network category scores 605 may be one or more category scores assigned to user device 180a, for example, as calculated by an exemplary algorithm to compute a category-based influence as described in FIG. 8 based on other social networks 604. (5) user category influence score 606 may be a category influence score assigned to user device 180a based on this social network 603 (6) reservations 607 may be, for example, reservations of units, shares, or some other opportunity or entity in a competition. Once an object is configured, it may be stored in user database 115 and the user is configured within category-based influence calculation system 130.

Further according to the embodiment, company object 610 may define characteristics about one or more users designated as a company for social influence score calculation system 100 and comprises, at least, fields: (1) user object 601 which is an object-oriented relationship to user object 601 through inheritance (as is known in the art) comprising, at least, the fields described above corresponding to user object 601. (2) competitions 612 may be one or more competitions corresponding to company 610 that an associated company may be hosting, for example, a share reservation competition for a pre-IPO offering, a sporting event wagering system, or some other competition. Competitions 612 may correspond to one or more competition objects 630.

Further according to the embodiment, influence score object 620 may define a plurality of data structures for configuring category scores according to an exemplary embodiment, and may comprise, at least: (1) category 621 defining the subject category for an instance of influence score 620. Categories may include, for example, investment categories such as, basic materials, conglomerates, consumer goods, energy, financial, health, healthcare, industrial goods, property, services, technology, utilities, and the like. In some embodiments, category 621 may comprise sporting categories, such as endurance, fantasy, field sports, court sports, amateur sports, football, hockey, table sports, and the like. (2) self-category performance 622 may indicate a performance rating for this social network 603 of an associated user object 601 for category 621. That is, a historical performance calculation for user object 601 based on historical involvement specifically for competitions corresponding to category 621. (3) self non category performance 623 may indicate a performance rating for an associated user object 601 based on historical involvement specifically for competitions not corresponding to category 621. (4) connection category performance 624 may indicate a performance rating for one or more user objects 601 connected to an associated user object 601 (for example, social connections in a social network), based on historical involvement specifically for competitions corresponding to category 621. (5) connection non category performance 625 may indicate a performance rating for one or more user objects 601 connected to an associated user object 601 (for example, social connection in a social network), based on historical involvement specifically for competitions not corresponding to category 621.

Further according to the embodiment, competition object 630 may define a data structure for configuring a competition for an associated competition object 610, and may comprise, at least: (1) competition name 631 may be a name for a competition. (2) competition ID 632 may be a unique identifier assigned to an instance of competition object 630, for example, when it is configured by a user device corresponding to company object 610. (3) category 633 defines a category associated to competition object 630, for example, an investment category (as outlined above), or the like. (4) isActive 634 is a state for the competition associated to competition object 630. It should be appreciated that a competition may be active during a competitive phase and inactive once certain thresholds have been reached or before (or after) a competition is executed. (5) start date 635 may be a calendar date (or time, or both) for when a competition corresponding to competition object 630 becomes active. (6) end date 636 may be a calendar date (or time, or both) for when a competition corresponding to competition object 630 is complete or expires. (7) total shares 637 may be an opportunity, for example, a number of units in, for example, a pre-IPO company corresponding to company object 610 associated to competition object 630. In some embodiments, total shares 640 may be a total number of unites available for purchase and a bonus. In some embodiments, total shares 640 may be a fixed number of units at the beginning of a competition. In some embodiment, total shares 640 may be topped before, during, or after an active or inactive campaign. (8) purchasable shares 638 may be a pre-specified amount of units available for reservation or purchase corresponding to company object 610 associated to competition object 630. (9) bonus shares 639 may be a pre-specified number of units available as bonus for a user object 601 associated to competition object 630 (for example, a participant) that may be earned by performing some prescribed action such as marketing activities (for example, sharing a post on social media, starting an email campaign, or the like). (10) bonus shares viral 641 may be units reserved for results from viral spread, shares, retweets for competition object 630. (11) bonus shares reserving 642 may be units reserved for results from unit reservations from a plurality of user objects 601. (12) bonus shares executing 643 may be units reserved for results from unit executed (for example, purchased) from a plurality of user objects 601. (13) summed bonus shares 644 may be a total of units from bonus shares viral 641, bonus shares reserving 642, and bonus shares executing 643. It should be appreciated that summed bonus shares 644 may differ from bonus shares 639 if parameters changed within the execution of a competition. (14) referring users 645 may be a plurality of user objects 601 that have been given referring status (that is, have performed prescribed actions described above), and may be used to compute bonus payouts. In some embodiments, during a competition associated to competition object 630, new users may be added dynamically to referring users 645. (15) viral sharing 646 may keep track of all the viral spread, shares, retweets, or any combination thereof, for a competition associated to competition object 630. (16) reservations 647 list of reservations for a competition associated to competition object 630. Reservations 647 may correspond to one or more reservation objects 650. (17) payouts 648 may define a payout status that may be computed at end date, or, in some embodiments, during an active period of a competition associated to competition object 630 (for example, as a progress indicator). In some embodiments, a portion of payouts 648 may be associated to one or more user objects 601. In some embodiments, pre-specified amounts for fields within competition object 630 may vary during the competition. On some embodiments, pre-specified amounts for fields within competition object 630 may be dynamic and change based on characteristics of interactions within category-based influence calculation system 130 during the competition.

Further according to the embodiment, reservation object 650 may define a data structure for keeping tracks of a set of reservation of units for an associated competition object 610, and may comprise, at least: (1) competition ID 651 may be a competition ID corresponding to competition ID 623 of an associated competition object 630. (2) category 652 may be a category corresponding to category 633 of an associated competition object 630. (3) quantity 653 may be a quantity of shares (or opportunities) reserved or executed (for example, purchased opportunities). (4) price 654 may be a price associated with a reservation corresponding to reservation object 650. (5) isExecuted 655 identifies whether a corresponding reservation object 650 is a reservation of an opportunity (i.e. isExecuted 655 is false), or when a reservation has been executed (for example, a purchased reservation) isExecuted 655 is true. (6) user referral 656 may indicate an associated user object 601 that may get a referral bonus for the associated reservation object 650 at the end of an associated competition object 630. For example, when an end date 636 associated to competition object 630 is reached.

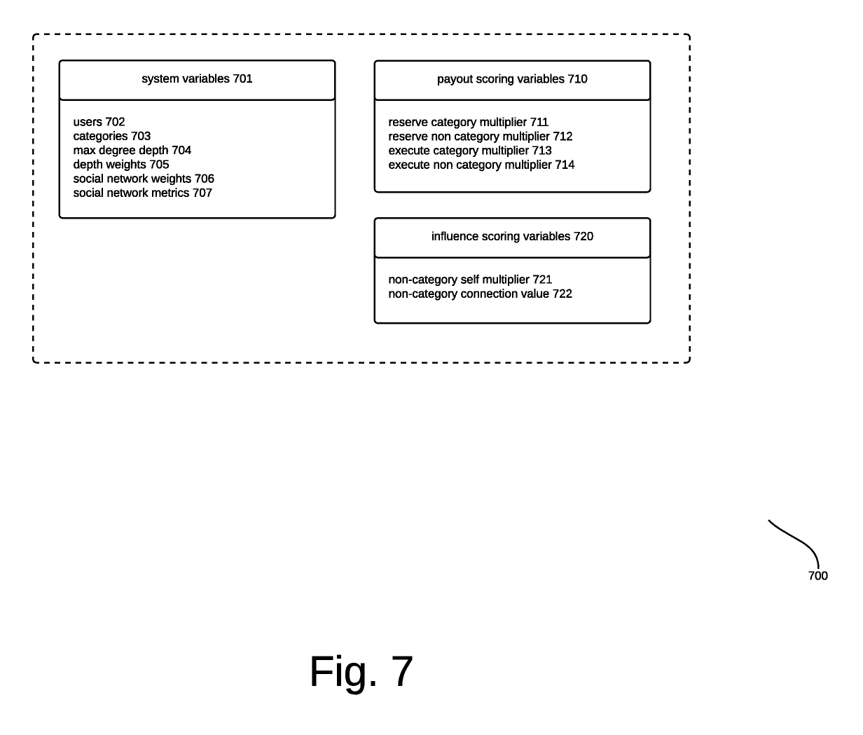

FIG. 7 is a block diagram illustrating a plurality of exemplary global variables for a computer-implemented automated category-based social influence score calculation, according to an exemplary embodiment. According to the embodiment, system variables 701 may define variables for implementing various exemplary embodiments of the invention, and may comprise, at least: (1) users 702 may be a list of user devices 180a-n configured to participate in influence calculation category-based influence calculation system 130. (2) categories 703 may be a master list of categories (for example, basic materials, conglomerates, consumer goods, energy, financial, health, healthcare, industrial goods, property, services, technology, utilities. In some embodiments, categories may comprise sporting categories, such as endurance, fantasy, field sports, court sports, amateur sports, football, hockey, table sports, and the like) available for configuring categories for category-based influence calculation system 130. (3) max degree depth 704 may configure a maximum number of degrees (for example, generations) that may be used to calculate category-based social influence, for example, as outlined in FIG. 5. (4) depth weights 705 may configure a weighting co-efficient for one or more degrees, for example, as outlined in FIG. 5. (5) social network weights 706 may weigh the value of a social network, for example, business networks such as LinkedIn™ may be weighted higher for certain categories such as business-related categories whereas other social networks, for example SnapChat™ may be weighted lower in the same category. Facebook™ may be weighted higher for environmental categories, whereas LinkedIn™ may be weighted lower. (6) social network metrics 707 may be information used in calculations each whereby each social network may have a set of metrics that are used to compute various scores for that specific network, for example, followers, retweets, and the like. In some embodiments, social network metrics 707 may also be weighted.

Further, according to the embodiment, payout scoring variables 710 may define variables for implementing various exemplary embodiments of the invention, and may comprise, at least: (1) reserve category multiplier 711 which may be a multiplier for calculating a payout when reservations occur corresponding to a category-based reservation. (2) reserve non category multiplier 712 which may be a multiplier for calculating a payout when reservations occur corresponding to a non-category-based reservation. (3) execute category multiplier 713 which may be a multiplier for calculating a payout when an execution occurs corresponding to a category-based reservation. (4) execute non category multiplier 714 which may be a multiplier for calculating a payout when an execution occurs corresponding to a non-category-based reservation.

Further, according to the embodiment, influence scoring variables 720 may define variables for computing influence scores and for implementing various exemplary embodiments of the invention, and may comprise, at least: (1) non-category self multiplier 721 may be a multiplier for non-category transactions for user device 180a (associated to a user object 601) whereby an influence score may be computed. (2) non-category connection value 722 may be a value for non-category transactions for connections associated to user device 180a associated to user object 601 whereby an influence score may be computed. That is, by calculating multipliers for non-category transactions, a reduction may be applied for non-category scoring. In other words, taking into account non-category performance for an influence score to be computed.

FIG. 8 is a flow diagram illustrating an exemplary algorithm to compute a category-based influence score for a computer-implemented automated category-based social influence score calculation, according to a preferred embodiment of the invention. According to the embodiment, in a first step 801 a distance weighting is calculated. That is, as you traverse generations of connections (for example, as outlined in FIG. 5) to calculate an overall influence score, the effect of a score is reduced. In some embodiments, node (or generation) depths may be set according to pascals triangle. An exemplary code segment for performing this function is as follows:

Function setNodeDepthWeights(Integer max_degree_depth){

Array<Integer, Double> return_value = [ ]
for (i = 1; i <= max_degree_depth; i++) {

weight = return_value.add(i, weight)

}

}

In this regard, weight may be a modifier between 0 and 1 that will modify the contribution of the influence score of a child user in a parent user's social network based on the edge distance.

In a next step 802, in order to not double count duplicate child users (for example, connections in successive generations as in FIG. 5) in a parent user's network, a function to remove duplicates is executed. For example, if first user device 180a and second user 180b are connected to third user 180c, and the first user device 180a is also connected to 180b, step 802 may eliminate counting user device 180a when computing user device 180b's influence score with respect to user device 180c. An exemplary code segment for performing this function is as follows:

Function duplicateEliminator(User u , Graph g){

Graph return_value = [ ]
return_value =

elimiateDuplicateNodesWithHigestEdgeDistance(u,g)

return return_value

}

It should be appreciated that the code segment above may include, in some embodiments, computation complexity algorithms such as approximation algorithms, that may include, for example, NP-Complete decision problems such as those for graph theory, as is known in the art.

In next steps 803 to 806, a plurality of connected social networks, connected to user device 180a (associated to user object 601), are retrieved and a score may be returned for each category. An exemplary code segment for performing this function is as follows:

Function computeOtherSocialNetworkScores(Array<String,
Graph> other_networks){

Array<String, Double> return_value = [ ]
for each (String c in categories) {

for each (Graph g in other_networks) {

Double temp = 0
value = computeSocialNetworkScore(g, c,

other_social_network_metrics.get(c))

temp +=

value*other_social_network_weights.get(g.name)

}
return_vale.add(c, temp)

}
return return_value

}

In step 804, a category is selected. In a next step 805, a score is calculated for the category for a social network whereby each metric function is applied to a given social network in a given category. An exemplary code segment for performing this function is as follows:

Function computeSocialNetworkScore(Graph g, Category c,
Array<Function> metrics){

return_value = 0
for each(Function f in metrics){

return_value += f(g,c)

}
return return_value

}

In some embodiments, this function may be called by the previous function, as shown. In a next step 806 a score is returned and iterates back to step 804 to consider the next category.

In steps 807 to 811, a user associated to a user device 180a-n with a corresponding user object 601, for example user device 180a, an influence score is computed for each category for based on performance (for example, historical performance) within category-based influence calculation system 130. An exemplary code segment for performing this function is as follows:

Function computeShareShopInfluenceScores(User u){

Array<String, InfluenceScore> return_value = 0
new_graph = duplicateEliminator(u

,u.this_social_network) for each(String c in categories){
InfluenceScore influencescore = [ ]

influencescore.self_category_performance =

computeSelfCategoryPerformance(u,c,new_graph)

influencescore.self_non_category_performance =

computeSelfNonCategoryPerformance(u,c,new_graph)

influencescore.connection_category_performance =

computeConnectionCategoryPerformance(u,c,new_graph)

influencescore.connection_non_category_performance =

computeConnectionNonCategoryPerformance(u,c,new_graph)

return_value.add(c,influencescore)

}
return return_value

}

In step 808, a self-category score is computed based on the behavior of the user associated to user device 180a (corresponding to user object 601) within the category whereby connections (and their influence) are not considered in the influence score calculation. An exemplary code segment for performing this function is as follows:

Function computeSelfCategoryPerformance(User u, String c,
Graph new_graph) {

Double return_value = 0
metrics = social_network_metrics.get(“ShareShop”)
for each (Funtion f in metrics){

return_value += f(g,c)

}

whereby, for example, metrics is a collection of metric functions for category-based influence calculation system 130. It should be appreciated that the output of step 808 may be different functions, for example, number of connections (or friends, or both), number of relevant articles, ratio of executions over reserves, and the like.

In a next step 809, a self-non-category score is computed based on the behavior of the user associated to user device 180a (corresponding to user object 601) not within the category whereby connections (and their influence) are not considered in the influence score calculation. An exemplary code segment for performing this function is as follows:

Function computeSelfNonCategoryPerformance(User u, String
c, Graph new_graph) {

Double return_value = 0
metrics = social_network_metrics.get(“ShareShop”)
for each (Funtion f in metrics){

return_value +=

f(g,c)*non_category_self_multiplier

}
return_value += u.reservations.sum(quantity*price &

category != c &
false(isExecuted))*reserve_non_category_multiplier

return_value += u.reservations.sum(quantity*price &

category != c &
true(isExecuted))*execute_non_category_multiplier

return return_value

}

whereby a reduction multiplier is included for a transaction not being within the category (for example, a competition category). It can be appreciated that in a category-based influence calculation, an influence score may be penalized for activity not being within category but non-category consideration may still be included in the category-based influence calculation since it may provide information on how influential a user may be in general.

In a next step 810, a connection category score is computed based on the behavior of connections associated to the user associated to user device 180a (corresponding to user object 601) within the category in a category-based influence score calculation. An exemplary code segment for performing this function is as follows:

Function computeConnectionCategoryPerformance(User u,
String c, Graph new_graph) {

Double return_value = 0
for each (User v in new_graph != u){

return_value +=

v.this_user_category_influencescores.get(c)*node_depth_weig
hts.get(v.edgeDistance(u))

return_value += v.reservations.sum(quantity*price

& category == c &
false(isExecuted))*reserve_category_multiplier

return_value += v.reservations.sum(quantity*price

& category == c &
true(isExecuted))*execute_category_multiplier

}
return return_value

}

It should be appreciated by one with ordinary skill that other scoring functions may be included in the for loop above to enrich the score calculation or take into account other factors.

In a next step 811, a connection non-category score is computed based on the behavior of connections associated to the user (who is associated to user device 180a and corresponding to user object 601) not within the category in a category-based influence score calculation. An exemplary code segment for performing this function is as follows:

Function computeConnectionNonCategoryPerformance(User u,
String c, Graph new_graph) {

Double return_value = 0
for each (User v in new_graph != u){

return_value +=

non_category_connection_value*node_depth_weights.get(v.edge
Distance(u))

return_value += v.reservations.sum(quantity*price

& category != c &
false(isExecuted))*reserve_non_category_multiplier

return_value += v.reservations.sum(quantity*price

& category != c &
true(isExecuted))*execute_non_category_multiplier

}
return return_value

}

It should be appreciated by one with ordinary skill in the art that other scoring functions may be included in the for loop above to enrich the score calculation or take into account other factors.

In a final step 812, a combined influence score is returned based on results computed previously in steps 808 to 811 to produce an influence score for user 180a with an associated user object 601.

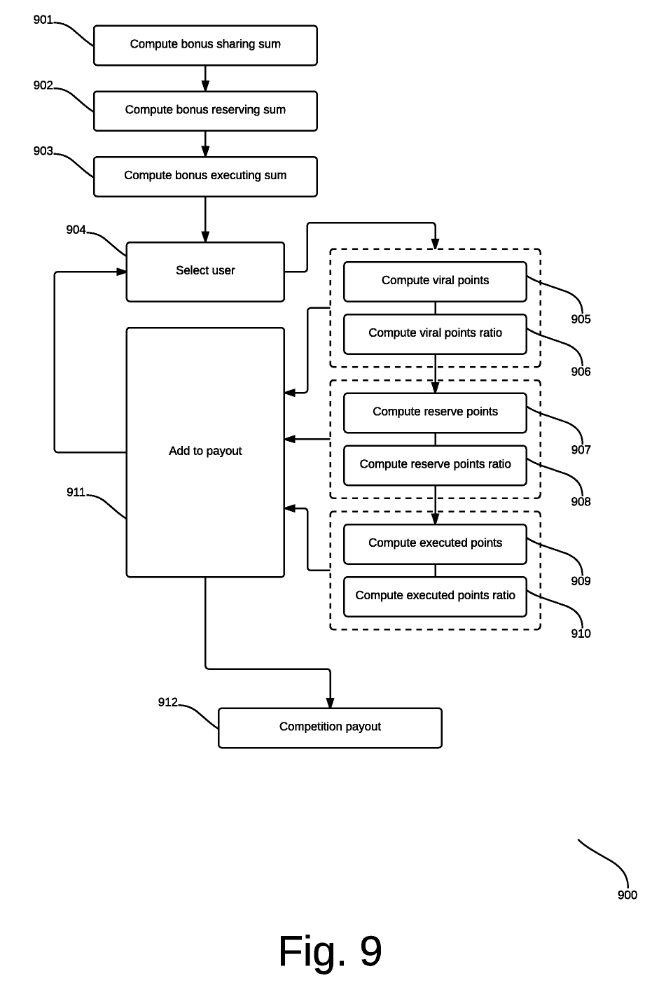

FIG. 9 is a flow diagram illustrating an exemplary algorithm to compute a competition payout for a computer-implemented automated category-based social influence score calculation, according to an exemplary embodiment. According to the embodiment, in steps 901 to 903, three variables are computed in order to know how much of an available payout each user will be assigned given each user's influence. It should be appreciated that user devices 180a-n (each associated to a user object 601) may have a different influence score and may change during execution of category-based influence calculation system 130. In some embodiments, a real-time dashboard may display payout values to show user devices 180a-n current performance information for example, for a category within an active competition which, in some embodiments, may still be subject to change until the competition reaches its end-time as configured in end data 636. An exemplary code segment for performing these functions is as follows:

Function payoutBonusShared(IPO_Competition competition){

Array<User,Payout> return_value = 0
total_denominator_viral =

computeBonusSharingSum(competition.referring_users,
competition.viral_shares)

total_denominator_reserved =

computeBonusReservingSum(competition.referring_users,
competition.reservations)

total_denominator_executed =

computeBonusExecutingSum(competition.referring_users,
competition.reservations)

for each (User u in competition.referring_users) {

payout = 0
viral_points =

sum(competition.viral_sharing.get(user ==
u))*u.InfluenceScore.get(category)

viral_points_ratio =

viral_points/total_denominator_viral

payout +=

competition.bonus_shares_viral*viral_points_ratio

reserved_points =

sum(competition.reservations.get(referral == u,
false(isExecuted)))*u.InfluenceScore.get(category)

reserved_points_ratio =

reserved_points/total_denominator_reserved

payout +=

competition.bonus_shares_reserving*reserved_points_ratio

executed_points =

sum(competition.reservations.get(referral == u,
true(isExecuted)))*u.InfluenceScore.get(category)

executed_points_ratio =

executed_points/total_denominator_executed

payout +=

competition.bonus_shares_executing*executed_points_ratio

return_value.add(u, payout)

}
return return_value

}

In a first step 901, a total of share events (for example, sharing a competition opportunity) across all relevant users is computed in order to payout all participating user devices 180a-n accordingly. An exemplary code segment for performing this function is as follows:

Funtion computeBonusSharingSum(Array<User> users,
Array<User, ShareEvents> viral_sharing){

Double return_value = 0
for each (User u in users) {

points = sum(viral_sharing.get(user ==

u))*u.InfluenceScore.get(category)

return_value += points

}
return return_value

}

In a next step 902, a total number of reservations across all relevant users is computed. An exemplary code segment for performing this function is as follows:

Funtion computeBonusReservingSum(Array<User> users,
Array<Reservation> reservations){

Double return_value = 0
for each (User u in users) {

points = sum(reservations.get(referral == u,

false(isExecuted)))*u.InfluenceScore.get(category)

return_value += points

}
return return_value

}

In a next step 903, a total number of executed opportunities across all relevant user devices 180a-n is computed. An exemplary code segment for performing this function is as follows:

Funtion computeBonusExecutingSum(Array<User> users,
Array<Reservation> reservations){
Double return_value = 0

for each (User u in users) {

points = sum(reservations.get(referral == u,

true(isExecuted)))*u.InfluenceScore.get(category)

return_value += points

}
return return_value

}

In a next step 904, A user device 180a (corresponding to user object 610) is selected to calculate the individual payout. Steps 905 and 906 compute viral points and a viral points ratio for user device 180a. For example, a calculation indicating how well sharing opportunities functioned for the user. That is, a production in opportunity awareness via social media self-replicating viral processes, analogous to the spread of viruses or computer viruses, as is known in the art. The result is added to a payout accumulation in step 911. In steps 907 and 908, a calculation of how many opportunities were reserved by other user devices 180b-n resulting from sharing by user device 180a. The result is added to a payout accumulation in step 911. In steps 909 to 910, a calculation of how many reserved opportunities were executed by other user devices 180b-n resulting from sharing by user device 180a. The result is added to a payout accumulation in step 911. Once a final payout is computed for user device 180a, it is associated to user device 180a and the process begins again at step 904 for the next user. Once the process is complete for all user relevant user devices 180a-n, a final competition payout is calculated in step 912 and stored in field payouts 648 of competition object 630 (referring to FIG. 6)

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

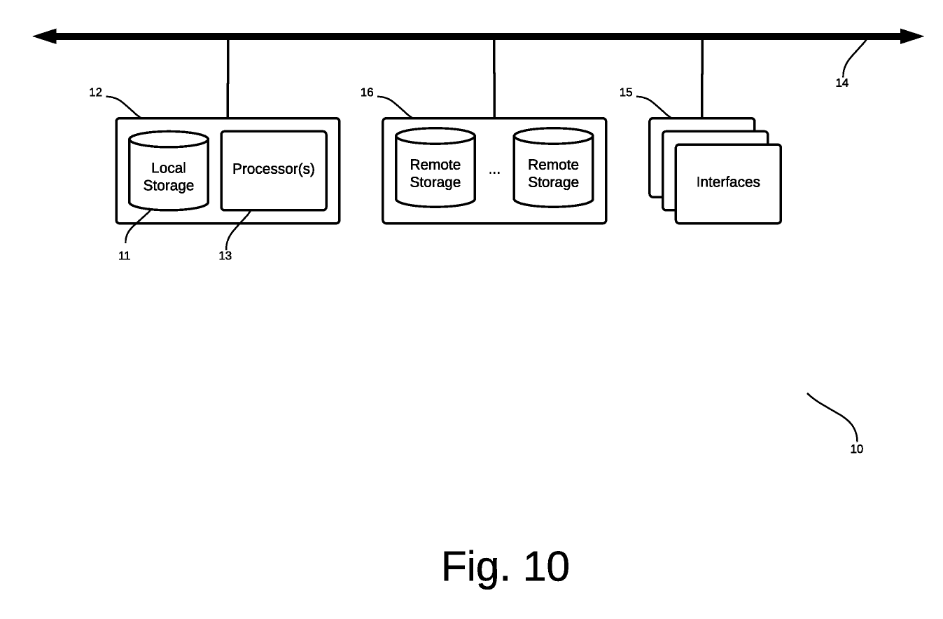

Referring now to FIG. 10, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 10 illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

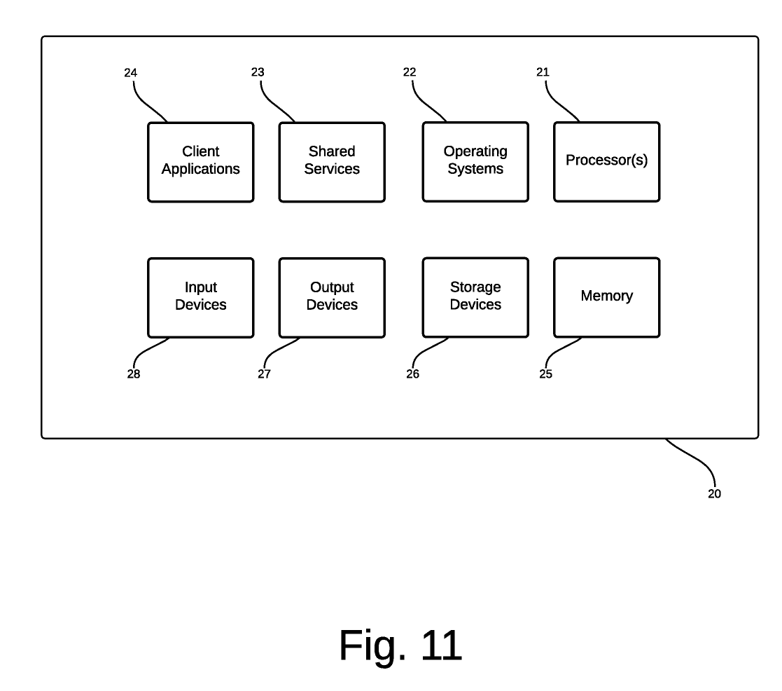

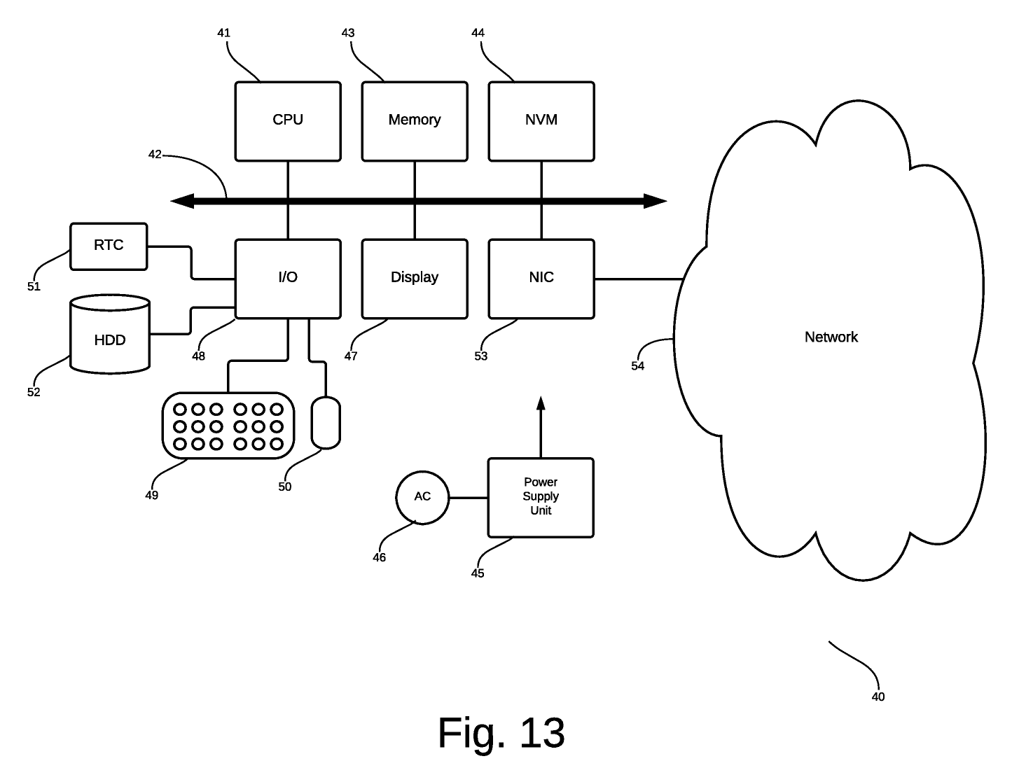

In some embodiments, systems according to the present invention may be implemented on a standalone computing system. Referring now to FIG. 11, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 13). Examples of storage devices 26 include flash memory, magnetic hard drive, CD-ROM, and/or the like.

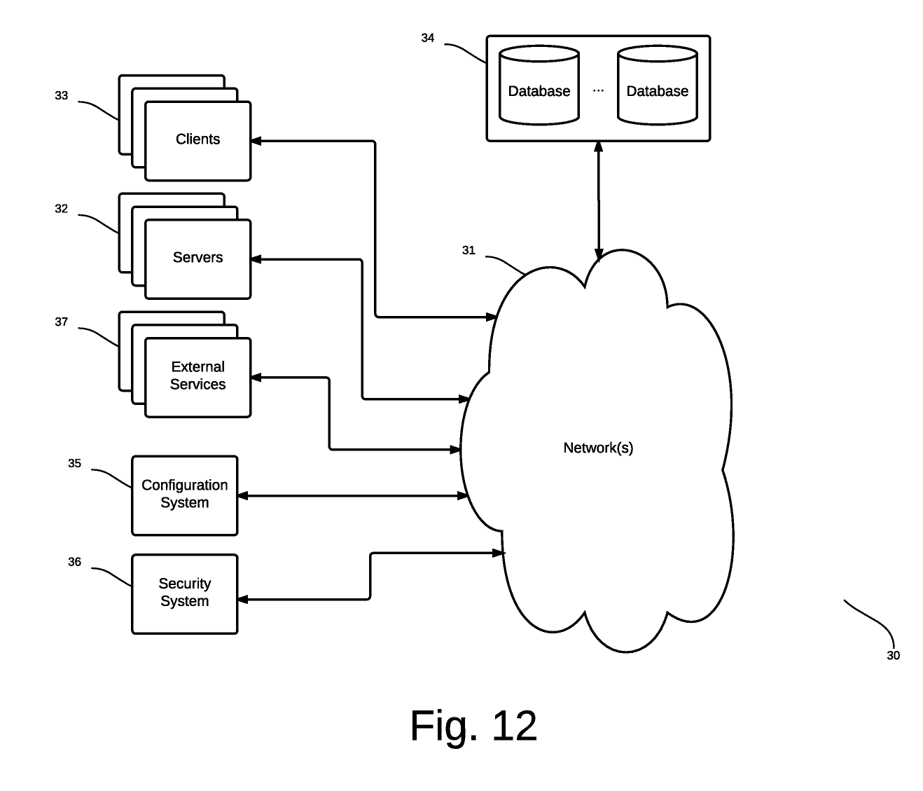

In some embodiments, systems of the present invention may be implemented on a distributed computing network, such as one having any number of clients and/or servers. Referring now to FIG. 12, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated in FIG. 5. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

FIG. 13 shows an exemplary overview of a computer system 40 as may be used in any of the various locations throughout the system. It is exemplary of any computer that may execute code to process data. Various modifications and changes may be made to computer system 40 without departing from the broader spirit and scope of the system and method disclosed herein. CPU 41 is connected to bus 42, to which bus is also connected memory 43, nonvolatile memory 44, display 47, I/O unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to ac supply 46. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

The skilled person will be aware of a range of possible modifications of the various embodiments described above. Accordingly, the present invention is defined by the claims and their equivalents.

What is claimed is:

1. A method for calculating a category-based social influence score, the method comprising:
deploying a network-connected category-rating computer comprising at least a memory and a processor and further comprising programmable instructions stored in the memory and operating on the processor, the instructions configured to rating social influence by category, comprising the steps of:
receiving a plurality of connections from a plurality of user devices, each user device associated to a corresponding user object of a plurality of user objects;
receiving a plurality of category objects associated to a first user object, each category object associated to a category;
receiving a plurality of connection objects associated to the first user object, each connection object associated to a social network;
accessing a social network using access criterion from a first connection object
receiving a plurality of social network connections associated to the first connection object, each social network connection having a plurality of attributes;
storing the plurality of social network connections with the associated plurality of attributes as nodes in a hierarchical tree structure, each successive generation of nodes based on degrees of separation to the first user object;
recursively calculating the number of nodes in the hierarchical tree structure based on a first category;
calculating, at a score calculator, a category-based influence score for a first user object based on historical performance and the nodes.

2. The method of claim 1, wherein each generation of nodes is weighted by generation, the weighting reducing the weight of each successive generation.

3. The method of claim 2, wherein the category-based influence score considers all nodes in the hierarchical tree structure.

4. The method of claim 1, wherein the category-based influence score is proportional to a commission rate.

5. The method of claim 4, wherein the commission rate is used to calculate a unit of account for an investment.

6. The method of claim 5, wherein the unit of account are shares of a company.

7. The method of claim 1, wherein the category is determined by word-spotting analysisg of a plurality of social media content associated to the first user-object

8. A system for calculating a category-based influence score, comprising:
a network-connected category-based influence scoring computer comprising at least a memory and a processor and further comprising programmable instructions stored in the memory and operating on the processor, the instructions configured to scoring social influence by category, comprising:
a plurality of categories;
a score calculator;
a plurality of connections to plurality of social networks;
a plurality of connections to a plurality of user devices;
a plurality of user objects, each associated to a user device of the plurality of user devices;
wherein a category-based historical performance for a first user object is computed based on a first category;
wherein a non-category-based historical performance for the first user object is computed not based on the first category;
wherein the score calculator combines the category-based historical performance and the non-category-based historical performance to compute a category based influence score.

9. The system of claim 8, further wherein the category-based historical performance and the non-category-based historical performance are weighted based on importance.

10. The system of claim 9, wherein a plurality of social connections associated to the first user object are retrieved from the plurality of social networks and stored in a hierarchical tree structure.

11. The system of claim 10, wherein duplicate connections are removed.

12. The system of claim 11, further wherein a category-based historical performance for the plurality of social connections associated to a first user object is computed based on the first category;
further wherein a non-category-based historical performance for the plurality of social connections associated to the first user object is computed not based on the first category;
further wherein the score calculator further combines the category-based historical performance and the non-category-based historical performance for the plurality of social connections, to compute the category-based influence score.

13. The system of claim 12, wherein a predefined number of generations of the hierarchical tree structure are considered.

14. The system of claim 13, wherein each generation is weighted based on distance from the first user object.

15. The system of claim 14, wherein the score calculator scores each social network based on the first category, further wherein the plurality of social connections are each weighted based on the score of their associated social network.

16. A method for calculating a category-based influence score, comprising the steps of:
deploying a network-connected category-based influence scoring computer comprising at least a memory and a processor and further comprising programmable instructions stored in the memory and operating on the processor, the instructions configured to scoring social influence by category;
scoring, at a score calculator, a plurality of connected social networks based on a category;
computing, at the score calculator, a category-based historical performance for a user object, based on the first category;
computing, at the score calculator, a non-category-based historical performance for the user object is computed not based on the first category;
combining, at the score calculator, the category-based historical performance and the non-category-based historical performance to compute a category-based influence score.

17. The method of claim 16, wherein the category-based historical performance and the non-category-based historical performance are weighted based on importance.

18. The method of claim 16, further comprising the steps of:
retrieving a plurality of social connections associated to the user object from the plurality of connected social networks;
storing the social connections in a hierarchical tree structure.

19. The method of claim 18, further comprising the step of removing duplicate connections.

20. The method of claim 19, further comprising the steps of:
computing, at the score calculator, a category-based historical performance for the plurality of social connections associated to the user object based on the first category;
computing, at the score calculator, a non-category-based historical performance for the plurality of social connections associated to the user object not based on the first category;
further combining, at the score calculator, the category-based historical performance and the non-category-based historical performance for the plurality of social connections, to compute the category-based influence score.
